(19) United States
(12) Patent Application Publication
(10) Pub. No.: US 2006/0183829 A1
(43) Pub. Date: Aug. 17, 2006

(54) Polytrimethylene terephthalate composition and process for producing the same

(76) Inventors: Katsuhiro Fujimoto, KANAGAWA (JP); Yoichiro Azuma, Nobeoko (JP)

Correspondence Address: STAAS & HALSEY LLP, SUITE 700, 1201 NEW YORK AVENUE, N.W., WASHINGTON, DC, 20005, US

(21) Appl. No.: 10/549,593

(22) PCT Filed: Mar. 16, 2004
(86) PCT No.: PCT/JP04/03475

§ 371 Date: Sep. 19, 2005

(30) Foreign Application Priority Data
Mar. 17, 2003 (JP) 2003-072389

(51) Int. Cl. B32B 7/12; C08K 5/13

(52) U.S. Cl. 524/186; 524/323

(57) ABSTRACT

A PTT-based composition is provided such that the emission of hazardous acrolein formed during heat oxidation is suppressed and the deterioration of color is reduced, and a process for producing the same. The PTT-based composition comprises PTT, a compound having a phenolic hydroxy group (a) and a compound having a secondary amine structure (b), or comprises PTT and a compound having both a phenolic hydroxy group (a) and a secondary amine structure (b), and/or modified derivatives of these compounds.

### TECHNICAL FIELD

The present invention relates to a polytrimethylene terephthalate composition and a process for producing the same. More specifically, it relates to a polyester composition in which the polyester has a main repeating unit comprised of trimethylene terephthalate whereby the emission of acrolein during melt oxidation is suppressed, and to a process for producing the same.

### BACKGROUND ART

In recent years, polytrimethylene terephthalate (hereinafter may be abbreviated as “PTT”) has started receiving attention as a material that can be applied to carpets, clothing and the like, utilizing the features thereof, wherein when it is converted to a fiber, an epoch-making fiber can be obtained which combines properties similar to nylon fiber such as a soft feeling derived from its low modulus, an excellent elastic recovery, easy dyeability and the like, as well as properties similar to polyethylene terephthalate fiber such as wash-and-wear properties, dimensional stability, yellowing resistance and the like.

PTT can be obtained by polymerizing a lower alcohol diester such as terephthalic acid (hereinafter abbreviated as “TPA”) or dimethyl terephthalate (hereinafter abbreviated as “DMT”) with trimethylene glycol (hereinafter abbreviated as “TMG”) in a molten state using a small amount of an organic titanium compound as a catalyst, in the same manner as polyethylene terephthalate (hereinafter abbreviated as “PET”) and polybutylene terephthalate (hereinafter abbreviated as “PBT”) which have similar chemical structures to PTT.

Although PTT has received attention since it can be produced by a process similar to the processes for PET and PBT and has features that are not possessed by PBT and PET, PTT is known to emit hazardous acrolein during melt processing. Therefore, the technology to suppress the emission of acrolein is desired.

As a technology for suppressing the emission of acrolein, mixing of an organic substance containing nitrogen such as a polyamide with PTT in a molten state is known (for example, refer to Patent Document 1 below). However, when the present inventors actually practiced this process, the effect on suppressing the emission of acrolein was very small. In addition, the obtained polymer was of a fairly yellowish color.

Further, a technology for suppressing the emission of acrolein by blocking the terminal of PTT with a hindered phenol is known (for example, refer to Patent Document 2 below). However, when the present inventors actually practiced this process, the effect on suppressing the emission of acrolein was small as in Patent Document 1. In addition, the obtained polymer was of a fairly yellowish color. Namely, it was not a technology that is sufficient in suppression of acrolein and color tone.

Thus, there have been problems that, in the technology for suppressing the emission of acrolein when PTT is subjected to melt processing, no known technology has an adequate effect on the suppression and only a PTT-based composition with a yellowish color can be obtained.

Patent Document 1: WO00/58393

Patent Document 2: WO98/23662

### DISCLOSURE OF THE INVENTION

The problems to be solved by the present invention are to provide a PTT composition such that the emission of acrolein in melt processing is reduced, and the color of the PTT composition itself and that of the product obtained by melt processing are good.

As a result of extensive investigations by the inventors, it has been found that, surprisingly, the emission of acrolein can be significantly suppressed and a PTT composition with less discoloration can be obtained, by adding a compound having a phenolic hydroxy group represented by formula (1) and a compound having a secondary amine structure represented by formula (2), or a compound having both of the phenolic hydroxy group represented by formula (1) and the secondary amine structure represented by formula (2). The inventors have completed the present invention based on the above findings.

The present invention is as described below:

1. A polytrimethylene terephthalate composition comprising a polymer component together with a combination of Component A and Component B, and/or Component C, from 10 to 100% by mole of said polymer component being polytrimethylene terephthalate composed of trimethylene terephthalate repeating units, wherein:

the above described Component A is a compound having a phenolic hydroxyl group (a) represented by formula (1): 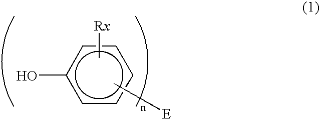
and/or a modified derivative thereof, wherein each R is independently selected from C₁₋₃₀ alkyl and at least one R is in the ortho position with respect to the phenolic hydroxy group; X is an integer of 1 to 4; E is C₅₋₅₀ hydrocarbyl or heterocarbyl; and n is an integer of 1 to 4;

the above described Component B is a compound having a secondary amine structure (b) represented by formula (2): 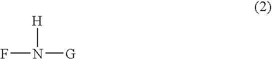
and/or a modified derivative thereof, wherein F and G may be a different or the same type of atom, but is not the same atom; and

the above described Component C is a compound having both of the group (a) and the group (b) in a molecule and/or a modified derivative thereof.

2. The composition according to the above described 1, wherein the total amount of the secondary amine structure contained in Components B and C is from 0.001 to 1.0 milliequivalent per mole of trimethylene terephthalate repeating units and the combined content of Components B and C is from 0.001 to 0.2% by weight relative to the entire composition.

3. The composition according to the above described 1 or 2, wherein each of the compounds of Components A, B and C is a stabilizer.

4. The composition according to the above described 1 which is a polytrimethylene terephthalate composition comprising a polymer component and the above described Component C, wherein from 10 to 100% by mole of the above described polymer component is polytrimethylene terephthalate composed of trimethylene terephthalate repeating units.

5. The composition according to any one of the above described 1 to 3, wherein Component B is at least one selected from the group consisting of a reaction product of N-phenylbenzenamine with 2,4,4-trimethylpentene, 3-(N-salicyloyl)amino-1,2,4-triazole which is a heavy metal deactivator available from Asahi Denka Co., Ltd., decamethylene carboxylic acid disalicyloyl hydrazide and modified derivatives thereof.

6. The composition according to any one of the above described 1 to 5, wherein Component C is at least one selected from the group consisting of N,N-hexane-1,6-diylbis[3-(3,5-di-tert-butyl-4-hydroxyphenyl)propionamide], 2,6-di-tert-butyl-4-(4,6-bis(octylthio)-1,3,5-triazin-2-ylamino)phenol and modified derivatives thereof.

7. The composition according to any one of the above described 1 to 6, further comprising a compound containing a sulfur atom and/or a modified derivative thereof, wherein the above described sulfur atom ranges from 0.001 to 1.0 millimole per mole of trimethylene terephthalate repeating units.

8. The composition according to the above described 7, wherein the compound containing a sulfur atom comprises a compound having a thioether group and/or a modified derivative thereof.

9. The composition according to any one of the above described 1 to 8, wherein from 10 to 80% by mole of the polymer component in the composition is composed of trimethylene terephthalate repeating units.

10. The composition according to the above described 9, wherein from 10 to 80% by mole of the polymer component in the composition is polytrimethylene terephthalate composed of trimethylene terephthalate repeating units, and from 90 to 20% by mole of the polymer component is composed of repeating units of at least one resin selected from the group consisting of a polyester, a polycarbonate and a polyolefin, other than polytrimethylene terephthalate.

11. The composition according to the above described 9, wherein from 90 to 20% by mole of the composition is at least one polymer selected from the group consisting of polyethylene terephthalate, polybutylene terephthalate, polyethylene naphthalate, a polycarbonate and a copolymer thereof mainly comprising the same.

12. A process for producing the polytrimethylene terephthalate composition according to any one of the above described 1 to 11, comprising adding a combination of Component A and Component B, and/or Component C, either directly or as a solution or a dispersion in a glycol mainly composed of trimethylene glycol, at any time point during the polymerization to the complete cooling of the product after the completion of the reaction.

13. A process for producing the polytrimethylene terephthalate composition according to any one of the above described 1 to 11, comprising incorporating a combination of Component A and Component B, and/or Component C during the kneading of the polymer.

14. A fiber or a molded article comprising the polytrimethylene terephthalate composition according to any one of the above described 1 to 11.

### BEST MODE FOR CARRYING OUT THE INVENTION

The polymer component contained in the polytrimethylene terephthalate composition (hereinafter may be abbreviated as “PTT composition”) of the present invention is a PTT composed of trimethylene terephthalate repeating units in an amount of from 10 to 100% by mole based on the above described polymer component. The above described PTT includes those containing one or more other components in an amount of 90% by mole or less. As described herein, the word “contain” means both of a case where other components are contained as a repeating unit of a copolymer and a case where other components are contained as a mixed component of a blend (also referred to as an alloy in some occasions). As described herein, the blend includes a case where a part of other polymers mixed therein is bonded to PTT.

Such copolymer components include 5-sodium sulfoisophthalic acid, 5-potassium sulfoisophthalic acid, 4-sodium sulfo-2,6-naphthalene dicarboxylic acid, tetramethylphosphonium 3,5-dicarboxylate benzenesulfonate, tetrabutylphosphonium 3,5-dicarboxylate benzenesulfonate, tributylmethylphosphonium 3,5-dicarboxylate benzenesulfonate, tetrabutylphosphonium 3,6-dicarboxylate naphthalene-4-sulfonate, tetramethylphosphonium 3,6-dicarboxylate naphthalene-4-sulfonate and ammonium 3,5-dicarboxylate benzenesulfonate. Copolymer components also include ester forming monomers such as 3,2-butanediol, 1,3-butanediol, 1,4-butanediol, neopentylglycol, 1,5-pentamethyleneglycol, 1,6-hexamethyleneglycol, heptamethyleneglycol, octamethyleneglycol, decamethyleneglycol, dodecamethyleneglycol, 1,4-cyclohexanediol, 1,3-cyclohexanediol, 1,2-cyclohexanediol, 1,4-cyclohexanedimethanol, 1,3-cyclohexanedimethanol, 1,2-cyclohexanedimethanol, oxalic acid, malonic acid, succinic acid, glutaric acid, adipic acid, heptanedioic acid, octanedioic acid, sebacic acid, dodecanedioic acid, 2-methylglutaric acid, 2-methyladipic acid, fumaric acid, maleic acid, itaconic acid, 1,4-cyclohexanedicarboxylic acid, 1,3-cyclohexanedicarboxylic acid and 1,2-cyclohexanedicarboxylic acid.

Furthermore, the blend components include polyesters such as PET, PBT and polyethylene naphthalate; polycarbonates such as a combination of bisphenol A and diphenyl carbonate and a combination of 1,4-butanediol and ethylene carbonate; polyolefins such as polystyrene, polyethylene, polypropylene and cycloaliphatic polyolefins; and copolymers primarily composed thereof. Aliphatic polyamides and polyamines are not preferable as they easily cause discoloration when mixed with PTT. Preparation of such blends or alloys is particularly useful in that an epoch-making composition may be obtained in which characteristics provided by PTT are combined with those of the components to be added. Specifically, representatives of particularly preferable blends include a blend of PTT with polycarbonates which has toughness, heat resistance, chemical resistance and dimensional stability; a blend of PTT with PBT which can enhance the rate of crystallization; and a blend of PTT with PET which has heat stability, toughness and chemical resistance.

When these alloys and blends are prepared, the trimethylene terephthalate repeating unit of the polymer component in the composition and the repeating unit of other polymers are preferably from 10 to 80% and from 90 to 20%, more preferably from 20 to 70% and from 80 to 30%, most preferably from 30 to 70% and 70 to 40%, by mole, respectively.

The PTT composition of the present invention is required to contain the above described combination of Component A and Component B, and/or Component C in the above described PTT.

First, Component A is described below among the above. Component A is a compound having a phenolic hydroxyl group (a) represented by formula (1) and/or a modified derivative thereof. Each R in the formula is independently selected from an alkyl group having 1 to 30 carbon atoms, which includes, for example, not only a linear alkyl group such as methyl, ethyl, propyl, butyl and pentyl, but also a branched alkyl group typified by tert-butyl and the like. When the number of carbon atoms exceeds 30, the effect on suppressing the emission of acrolein will be reduced due to the reduction of compatibility with PTT. In addition, if R is absent, the effect on suppressing the emission of acrolein will be considerably reduced. The number of carbon atoms in R is preferably from 1 to 20, more preferably from 1 to 10.

Among others, a tert-butyl group, which has 4 carbon atoms, is preferred in terms of suppressing acrolein emissions. In addition, at least one R is in the ortho position with respect to the phenolic hydroxyl group, and X, the number of R, is an integer of 1 to 4. Further, E is a hydrocarbyl or heterocarbyl group having 5 to 50 carbon atoms, and n is an integer of 1 to 4.

Incidentally, in the present invention, a modified derivative refers to a compound whose structure is changed by reaction with a solvent to be used for adding the same to PTT, reaction with PTT itself, thermal decomposition, decomposition by or reaction with oxygen, hydrolysis or polymerization of the compound itself.

As Component A, a stabilizer such as a hindered phenol antioxidant and modified derivatives thereof are preferred. Specific examples of the hindered phenol antioxidant include pentaerythritol-tetrakis(3-(3,5-di-tert-butyl-4-hydroxyphenyl)propionate), thiodiethylene-bis(3-(3,5-tert-butyl-4-hydroxyphenyl)propionate), octadecyl-3-(3-(3,5-di-tert-butyl-4-hydroxyphenyl)propionate), N,N′-hexane-1,6-diylbis (3-(3,5-di-tert-butyl-4-hydroxyphenyl)propionamide), benzenepropanoic acid, 3,5-bis(1,1-dimethylethyl)-4-hydroxy, C₇-C₉ side chain alkyl esters and 2,4-dimethyl-6-(1-methylpentadecyl)phenol. The examples also include diethyl((3,5-bis(1,1-dimethylethyl)-4-hydroxyphenyl)methyl)phosphonate, 3,3′,3″,5,5′,5″-hexa-tert-butyl-a,a′,a″-(mesitylene-2,4,6,-triyl)tri-p-cresol, calcium diethylbis(((3,5-bis(1,1-dimethylethyl)-4-hydroxyphenyl)methyl)phosphonate, 4,6-bis(octylthiomethyl)-o-cresol, ethylenebis(oxyethylene)bis(3-(5-tert-butyl-4-hydroxy-m-tolyl)propionate), hexamethylene bis(3-(3,5-di-tert-butyl-4-hydroxyphenyl)propionate, 1,3,5-tris(3,5-di-tert-butyl-4-hydroxybenzyl)-1,3,5-triazine-2,4,6(1H, 3H, 5H)-trione, 1,3,5-tris((4-tert-butyl-3-hydroxy-2,6-xylyl)methyl-1,3,5-triazine-2,4,6-(1H, 3H, 5H)-trione and 2,6-di-tert-butyl-4-(4,6-bis(octylthio)-1,3,5-triazin-2-ylamino)phenol.

Trade names of commercially available stabilizers include Irganox 1010, Irganox 1035, Irganox 1076, Irganox 1098, Irganox 1135, Irganox 1141, Irganox 1222, Irganox 1330, Irganox 1425WL, Irganox 1520, Irganox 245, Irganox 259, Irganox 3114, Irganox 3790, Irganox 565 and the like, available from Chiba Specialty Chemicals Corporation (“Irganox” is a trademark).

Next, Component B is described. Component B is a compound having a secondary amine structure (b) represented by formula (2) and/or modified derivatives thereof. In the formula, F and G may be a different or the same type of atom, but must not be the same atom. The formula does not include the case where the nitrogen atom in the formula forms a double bond with another atom. The compounds having a secondary amine structure (b) include a reaction product of N-phenylbenzenamine with 2,4,4-trimethylpentene (trade name: Irganox5057 or the like), N,N′,N″,N′″-tetrakis-(4,6-bis-(butyl(N-methyl-2,2,6,6-tetramethylpiperidin-4-yl)amino-)-triazin-2-yl)-4,7-diazadecane-1,10-diamine (trade name: Chimassorb 119FL available from Chiba Specialty Chemicals Corporation), a polycondensate of dibutylamine-1,3,5-triazine-N,N′-bis(2,2,6,6-tetramethyl-4-piperidyl-1,6-hexamethylenediamine and N-(2,2,6,6,-tetramethyl-4-piperidyl)butylamine (trade name: Chimassorb 2020FL available from Chiba Specialty Chemicals Corporation), poly((6-(1,1,3,3-tetramethylbutyl)amino-1,3,5-triazine-2,4-diyl)((2,2,6,6-tetramethyl-4-piperidyl)imino)hexamethylene((2,2,6,6-tetramethyl-4-piperidyl)imino)) (trade name: Chimassorb 944FD available from Chiba Specialty Chemicals Corporation and the like), bis(2,2,6,6-tetramethyl-4-piperidyl)sebacate (trade name: Tinuvin770 available from Chiba Specialty Chemicals Corporation and the like), 3-(N-salicyloyl)amino-1,2,4-triazole which is a heavy metal deactivator available from Asahi Denka Co., Ltd. (trade name: ADK STAB CDA-1), decamethylene carboxylic acid disalicyloyl hydrazide (trade name: ADK STAB CDA-6), LA-57, LA-77Y and LA-87 which are light stabilizers, 2-aminobenzamide (trade name: Triple A available from ColorMatrix Co.) and the like, and/or modified derivatives thereof. Among others, Irganox 5057, CDA-1 and CDA-6 and/or modified derivatives thereof are preferred in that the suppression of acrolein and discoloration can be balanced.

Polymers such as polyamides such as nylon 6/6, nylon 6 and nylon 4/6 and polyethyleneimine are effective on the suppression of acrolein emissions, as Component B other than the above. However, they are not preferred because the extent of suppression is not high and they are easily discolored when molded. In order to suppress scattering during drying and molding, the molecular weight of Component B is preferably not less than 300.

Lastly, Component C is described. Component C is a compound having both of the phenolic hydroxyl group (a) represented by formula (1) and the secondary amine structure (b) represented by formula (2), and/or modified derivatives thereof. Component C includes both the case where it is present in the polytrimethylene terephthalate composition without reacting with the polymer and the case where the above described organic group is incorporated in the terminal or molecular skeleton of the polymer by chemical bonding. When a compound having only the phenolic hydroxyl group (a) of formula (1) and/or a modified derivative thereof, or only a compound having the secondary amine structure (b) of formula (2) and/or a modified derivative thereof is present in the composition, the effect on suppressing the emission of acrolein which is generated during melt oxidation is very small. Two effects, that is, a very large effect on suppressing acrolein emissions and a good whiteness of molded articles, can be achieved at the same time, only when both a compound containing (a) of formula (1) and/or a modified derivative thereof and a compound containing (b) of formula (2) and/or a modified derivative thereof are present in the composition. Component C which is preferred includes a stabilizer such as N,N-hexane-1,6-diylbis(3-(3,5-di-tert-butyl-4-hydroxyphenyl)propionamide) (trade name: Irganox 1098 available from Chiba Specialty Chemicals Corporation), 2,6-di-tert-butyl-4-(4,6-bis(octylthio)-1,3,5-triazin-2-ylamino)phenol (trade name: Irganox 565 available from Chiba Specialty Chemicals Corporation) or 2,3-bis(3-(3,5-di-tert-butyl-4-hydroxyphenyl)propionyl)propionohydrazide (trade name: Irganox MD1024), or modified derivatives thereof.

It is preferable that the total amount of the above described secondary amine structure (b) contained in Component B and Component C is from 0.001 to 1.0 milliequivalent per mole of trimethylene terephthalate repeating unit, and that the content of Component B and Component C each having the secondary amine structure (b) in total is from 0.001 to 0.2% by weight relative to the entire PTT composition. Increase of the amount of the above described compound having the secondary amine structure can reduce the emission of acrolein during melt oxidation, but on the other hand it tends to cause problems such as the deterioration of the color, the reduction of strength and bleed out in resultant products. More preferably, the content of the secondary amine structure (b) is from 0.005 to 0.5 milliequivalent per mole of trimethylene terephthalate repeating unit, and the content of Component B and Component C in total is from 0.01 to 0.1% by weight relative to the entire PTT composition. Further preferably, the content of the secondary amine structure (b) is from 0.01 to 0.3 milliequivalent per mole of trimethylene terephthalate repeating unit, and the content of Component B and Component C in total is from 0.03 to 0.08% by weight relative to the entire PTT composition.

On the other hand, the phenolic hydroxyl group (a) exhibits its effect in an amount of a fairly wide range with little adverse effect. It is preferable that the total amount of the phenolic hydroxyl group (a) contained in Component B and Component C is from 0.001 to 10 milliequivalent per mole of trimethylene terephthalate repeating unit, and that the content of Component B and Component C each having the phenolic hydroxyl group (a) in total is from 0.001 to 2% by weight. The emission of acrolein can be reduced to some extent by increasing the amount of the above described compounds. However, the effect on suppressing the emission of acrolein will not be improved by further increasing the amount of the above compounds. Instead, the increase will tend to cause problems such as the deterioration of the color and bleed out in resultant products. Therefore, the above described range is preferred. More preferably, the content of the phenolic hydroxyl group (a) is from 0.005 to 5 milliequivalent per mole of trimethylene terephthalate repeating unit, and the content of Component B and Component C in total is from 0.005 to 1% by weight relative to the entire PTT composition. Most preferably, the content of the phenolic hydroxy group (a) is from 0.01 to 1 milliequivalent per mole of trimethylene terephthalate repeating unit, and the content of Component B and Component C in total is from 0.03 to 0.08% by weight relative to the entire PTT composition.

According to the present invention, the emission of acrolein during melt oxidation can be reduced by allowing the composition to contain the above combination of Component A and Component B, and/or Component C. In addition, the effect of the reduction can be further enhanced by allowing it to additionally contain a compound containing a sulfur atom and/or modified derivatives thereof.

The compound containing a sulfur atom may be any of those containing a sulfur atom in the molecular skeleton, and compounds having a sulfur atom in the form of a thioether group are more preferred. Incidentally, the above described compounds and/or modified derivatives thereof may or may not be incorporated in the skeleton of PTT. These compounds include didodecyl-3,3′-thiodipropionate and dioctadecyl-3,3′-thiodipropionate. Specifically, compounds derived from thioether antioxidants are preferred, which include Irganox PS 800FL and Irganox PS 802FL available from Chiba Specialty Chemicals Corporation (“Irganox” is a trademark), and ADK STAB AO-23 (CAS-No 66534-05-2), ADK STAB AO-412S (CAS-No 29598-76-3) and ADK STAB AO-503A (CAS-No 10595-72-9) available from Asahi Denka Co., Ltd. (“ADK STAB” is a trademark). Among others, the compound derived from ADK STAB A-412S is most preferred because of little deterioration of color.

The amount of the compounds containing sulfur and/or modified derivatives thereof ranges preferably from 0.001 mmol to 1.0 mmol in terms of mole quantity of sulfur atom, per mole of trimethylene terephthalate repeating unit. Increase of the mole quantity of sulfur atom can reduce the emission of acrolein during melt oxidation, but on the other hand it tends to cause the deterioration of the color, the reduction of strength and bleed out in resultant products. The amount of the above compounds ranges more preferably from 0.005 mmol to 0.5 mmol and most preferably from 0.01 mmol to 0.3 mmol, per mole of trimethylene terephthalate repeating unit.

According to the present invention, various additives, for example, delusterants, flame retardants, antistatic agents, antifoaming agents, toning agents, antioxidants, ultraviolet absorbers, crystal nucleating agents and brighteners may be copolymerized or mixed as necessary. These additives can be introduced at any stage of polymerization. In addition, inorganic fillers such as glass fibers, talk and wollastonite may also be incorporated.

A process for producing the PTT-based composition of the present invention is described below.

Typically, terephthalic acid or a lower alcohol diester of terephthalic acid such as dimethyl terephthalate and trimethylene glycol are subjected to an ester exchange reaction or direct esterification reaction without a catalyst or in the presence of a catalyst such as a metal carboxylate or titanium alkoxide to obtain bis(3-hydroxypropyl)terephthalate, which is then subjected to a polycondensation reaction to obtain PTT, in which the above described bis(3-hydroxypropyl)terephthalate is heated to a molten state under the presence of a catalyst such as titanium alkoxide or antimony oxide while trimethylene glycol, a by-product, is taken out of the system.

According to the present invention, a combination of Component A and Component B, and/or Component C can be added to the PTT reaction solution at any stage of typical PTT production. For example, a combination of Component A and Component B, and/or Component C can be dissolved or dispersed in trimethylene glycol to obtain a solution or a dispersion, which can then be added to a reaction solution for esterification reaction or ester exchange reaction to be subjected to polycondensation reaction; Alternatively, the above described compounds may be added after the completion of ester exchange reaction or esterification reaction, or may be added to the PTT composition once solidified after the completion of polycondensation reaction while it is molten by a kneader or the like. Furthermore, the order for adding these compounds is not limited, that is, any compound may be added first and all the compounds may be added at the same time.

In terms of suppressing the emission of acrolein and the color of the obtained polymer, a combination of Component A and Component B, and/or Component C are preferably added in the latter half of the production process. Specifically, these compounds are preferably added to the polymer after completion of polycondensation while it is in a molten state before being cooled and solidified, or to the polymer which is obtained by remelting a once solidified polymer in a kneader or the like. Although the exact reason is unclear, it is assumed that when these compounds are present in PTT from the initial stage of the polymerization, they are deteriorated due to a long heat history, reducing the effect on suppressing acrolein emissions and causing discoloration.

The PTT composition of the present invention can be subjected to melt spinning to obtain fibers, subjected to injection molding to obtain injection-molded articles or subjected to extrusion molding to obtain extrusion-molded articles, in the same manner as PTT compositions obtained by the state of the art or other polyester compositions such as PET and PBT. In addition, when such melt molding is implemented, the use of the PTT composition of the present invention can lead to a considerable reduction of the amount of acrolein emitted and reduced discoloration during molding, which makes it easy to obtain molded articles with high quality, compared with the use of PTT compositions obtained by the state of the art.

The present invention is described below further in detail by Examples, but the present invention is not limited to the Examples.

The main measurement values were determined by the following methods.

(1) Intrinsic Viscosity [η]

Intrinsic viscosity [η] was determined according to the formula below:

$$[ η ] = lim ( {η}_{sp} / C )$$

$$C -> 0$$

wherein the ratio ηₛₚ/C of specific viscosity ηₛₚ which is measured in o-chlorophenol at 35° C. using an Ostwald viscometer to the concentration C (g/100 ml) was extrapolated to zero concentration.
(2) Color (L-value, b*-value)

A color computer by Suga Test Instruments Co., Ltd. was used for the measurement.

(3) Amount of Acrolein Emission

Five grams of a polymer was uniformly placed in an aluminum dish with a diameter of 5.3 cm and brought into contact with 50 ml/min of air at 270° C. Acrolein emitted in 30 minutes was trapped in methanol cooled to −70° C. The amount of acrolein trapped in methanol was measured by gas chromatography.

### EXAMPLE 1

In a vertical agitation reactor with a turbine-type agitation blade, 1,300 kg of DMT, 1,120 kg of TMG and tetrabutyl titanate as a catalyst of an amount of 0.1% by weight based on the polymer to be obtained were charged and subjected to ester exchange reaction for 3 hours while increasing the temperature to 160 to 220° C. under normal pressure, thus obtaining a PTT oligomer. At the same time as the completion of the ester exchange reaction, 0.69 kg of Irganox 1076 (available from Chiba Specialty Chemicals Corporation) as Component A and 0.69 kg of Irganox 5057 (available from Chiba Specialty Chemicals Corporation) as Component B were dispersed in 69 kg of TMG, added to the obtained PTT oligomer and mixed for 5 minutes under normal pressure. Subsequently, the above described PTT oligomer was transferred to a vertical agitation reactor with an anchor-type agitation blade and subjected to polycondensation reaction under a reduced pressure at 260° C., thus obtaining a PTT-based composition. The pressure was decreased with time to a final pressure of 100 Pa. The same catalyst as used in the ester exchange reaction was used as a polycondensation catalyst without an additional catalyst. The obtained PTT composition had an intrinsic viscosity of 0.75 dl/g and a good color of L* of 90 and b* of 5. Moreover, the obtained PTT composition was evaluated for the emission of acrolein in the air at 270° C. The result showed a small amount of acrolein emission of 0.010% by weight per weight of polymer.

### EXAMPLE 2

Polymerization was carried out in the same manner as in Example 1 except that Irganox 1076 and Irganox 5057 were replaced by Irganox 1098 (available from Chiba Specialty Chemicals Corporation) as Component C. The obtained PTT composition had an intrinsic viscosity of 0.76 dl/g and a good color of L* of 91 and b* of 4. In addition, the amount of acrolein emission was 0.007% by weight.

### EXAMPLE 3

Polymerization was carried out in the same manner as in Example 2 except that ADEKA AO-412S (available from Asahi Denka Co., Ltd.) was added as a compound having a sulfur atom. The obtained PTT composition had an intrinsic viscosity of 0.76 dl/g and a good color of L* of 92 and b* of 2. In addition, the amount of acrolein emission was 0.004% by weight.

### EXAMPLE 4

Polymerization was carried out in the same manner as in Example 3 except that Irganox 1098 was changed to Irganox 565 (available from Chiba Specialty Chemicals Corporation) as Component C. The obtained PTT composition had an intrinsic viscosity of 0.76 dl/g and a good color of L* of 92 and b* of 2. In addition, the amount of acrolein emission was 0.004% by weight.

### COMPARATIVE EXAMPLE 1

Polymerization was carried out in the same manner as in Example 1 except that both Irganox 1076 and Irganox 5057 were not used. The obtained PTT composition had an intrinsic viscosity of 0.76 dl/g and a good color of L* of 93 and b* of 1. However, a very large amount of acrolein emission of 0.04% by weight was observed.

### COMPARATIVE EXAMPLE 2

Polymerization was carried out in the same manner as in Example 1 except that Irganox 1076 of 0.69 g was used as Component A, but Irganox 5057 was not used as Component B. The obtained PTT composition had an intrinsic viscosity of 0.76 dl/g and a good color of L* of 92 and b* of 2. However, a large amount of acrolein emission of 0.035% by weight was observed.

### COMPARATIVE EXAMPLE 3

Polymerization was carried out in the same manner as in Comparative Example 2 except that the amount of Irganox 1076 as Component A was increased to 6.9 kg. The obtained PTT composition had an intrinsic viscosity of 0.76 dl/g and a color of L* of 75 and b* of 21, which was very yellowish. The amount of acrolein emission was 0.015% by weight.

### COMPARATIVE EXAMPLE 4

Polymerization was carried out in the same manner as in Example 1 except that Irganox 1076 and Irganox 5057 were replaced by 0.69 kg of nylon 6.6 with a weight average molecular weight of 20,000. The obtained PTT-based composition had an intrinsic viscosity of 0.76 dl/g and a color of L* of 87 and b* of 10. However, a large amount of acrolein emissions of 0.034% by weight was observed.

### EXAMPLE 5

An adequately dried PTT composition in 1,380 kg obtained in Comparative Example 1 was kneaded with 0.69 kg of Irganox 1098 as Component A and 0.69 g of ADEKA AO-412S as a compound having a sulfur atom in a twin-screw extruder for uniform kneading and was pelletized. The obtained PTT composition had an intrinsic viscosity of 0.75 dl/g and a good color of L* of 93 and b* of 1. In addition, a very small amount of acrolein emission of 0.003% by weight was observed.

### COMPARATIVE EXAMPLE 5

Pellets were obtained in the same manner as in Example 5 except that Irganox 1098 and ADEKA AO-412S were replaced by 1.38 kg of Irganox 1076 and 3.45 kg of formamidine. The obtained PTT had an intrinsic viscosity of 0.75 dl/g, which was almost the same as that in Example 5, and a relatively small amount of acrolein emission of 0.013% by weight was also observed. However, a very yellow color of L* of 89 and b* of 23 was observed.

### EXAMPLE 6

Pellets were obtained in the same manner as in Example 5 except that 500 kg of PET with an intrinsic viscosity of 0.7 was added. The obtained PTT/PET blend (alloy) had an intrinsic viscosity of 0.74 dl/g and a good color of L* of 92 and b* of 2. In addition, a very small amount of acrolein emission of 0.002% by weight was observed.

### EXAMPLES 7 AND 8

Pellets were obtained in the same manner as in Example 6 except that the PET was replaced by 600 kg of PBT with an intrinsic viscosity of 0.9 in Example 7 and by 3,000 kg of PC with a weight average molecular weight of 20,000 in Example 8. The obtained PTT/PBT blend (alloy) and PTT/PC blend (alloy) had a good color of L* of 89 and 93 and b* of 3 and 1, respectively. A very small amount of acrolein emission of 0.002% by weight and 0.001% by weight was also observed, respectively.

TABLE 1

| | | Amount of | Amount of | Amount of | Intrinsic | | | Amount of |
|---|---|---|---|---|---|---|---|---|
| | Timing of | formula (1) | formula (2) | sulfur atom | viscosity | | | acrolein |
| | addition | compound (meq) | compound (meq) | (mmol) | (dl/g) | L* | b* | (wt %) |
| Example 1 | Add after | Irganox | Irganox | | 0.75 | 90 | 5 | 0.010 |
| | completion of | 1076 | 5057 | | | | | |
| | ester exchange | 0.15 | 0.49 | | | | | |
| Example 2 | Add after | Irganox | Irganox | | 0.76 | 91 | 4 | 0.007 |
| | completion of | 1098 | 1098 | | | | | |
| | ester exchange | 0.26 | 0.26 | | | | | |
| Example 3 | Add after | Irganox | Irganox | ADEKA | 0.76 | 92 | 2 | 0.004 |
| | completion of | 1098 | 1098 | A0-412S | | | | |
| | ester exchange | 0.26 | 0.26 | 0.28 | | | | |
| Example 4 | Add after | Irganox | Irganox | ADEKA | 0.76 | 92 | 2 | 0.004 |
| | completion of | 565 | 565 | A0-412S | | | | |
| | ester exchange | 0.12 | 0.12 | 0.28 | | | | |
| Comparative | Add after | | | | 0.76 | 93 | 1 | 0.040 |
| Example 1 | completion of | | | | | | | |
| | ester exchange | | | | | | | |
| Comparative | Add after | Irganox | | | 0.76 | 92 | 2 | 0.035 |
| Example 2 | completion of | 1076 | | | | | | |
| | ester exchange | 0.15 | | | | | | |
| Comparative | Add after | Irganox | | | 0.76 | 75 | 21 | 0.015 |
| Example 3 | completion of | 1076 | | | | | | |
| | ester exchange | 1.5 | | | | | | |
| Comparative | Add after | | Nylon6.6 | | 0.76 | 87 | 10 | 0.034 |
| Example 4 | completion of | | 0.73 | | | | | |
| | ester exchange | | | | | | | |
| Example 5 | Add after | Irganox | Irganox | ADEKA | 0.75 | 93 | 1 | 0.003 |
| | polymerization | 1098 | 1098 | A0-412S | | | | |
| | | 0.32 | 0.26 | 0.28 | | | | |
| Comparative | Add after | Irganox | Irganox | ADEKA | 0.75 | 89 | 23 | 0.013 |
| Example 5 | polymerization | 1098 | 1098 | A0-412S | | | | |
| | | 0.32 | 0.26 | 0.28 | | | | |
| Example 6 | Add after | Irganox | Irganox | ADEKA | 0.74 | 92 | 2 | 0.002 |
| | polymerization | 1098 | 1098 | A0-412S | | | | |
| | | 0.32 | 0.26 | 0.28 | | | | |
| Example 7 | Add after | Irganox | Irganox | ADEKA | Not | 89 | 3 | 0.002 |
| | polymerization | 1098 | 1098 | A0-412S | evaluated | | | |
| | | 0.32 | 0.26 | 0.28 | | | | |
| Example 8 | Add after | Irganox | Irganox | ADEKA | Not | 93 | 1 | 0.001 |
| | polymerization | 1098 | 1098 | A0-412S | evaluated | | | |
| | | 0.32 | 0.26 | 0.28 | | | | |

* Amount of formula (1) compound refers to milliequivalent of phenolic hydroxyl group per mol of repeating unit comprising PTT.
* Amount of formula (2) compound refers to milliequivalent of secondary amine per mol of repeating unit comprising PTT.
* Amount of sulfur atom refers to millimole of sulfur atom per mol of repeating unit comprising PTT.
* Amount of acrolein refers to the amount of acrolein (wt %) emitted in the air of 270° C. × 30 minutes based on the weight of polymer.

### INDUSTRIAL APPLICABILITY

Suppression of both hazardous acrolein emitted during heat oxidation and discoloration can be achieved by preparing a PTT composition comprising PTT, a compound having a phenolic hydroxyl group (a) and a compound having a secondary amine structure (b), or comprising PTT and a compound having both (a) and (b). This enables not only the suppression of acrolein emission when the PTT-based composition is converted to fibers or resins or when the product is handled, but also the production of products composed of the PTT composition with excellent color.

1. A polytrimethylene terephthalate composition comprising a polymer component together with a combination of Component A and Component B, and/or Component C, from 10 to 100% by mole of said polymer component being polytrimethylene terephthalate composed of trimethylene terephthalate repeating units, wherein:
said Component A is a compound having a phenolic hydroxy group (a) represented by formula (1): 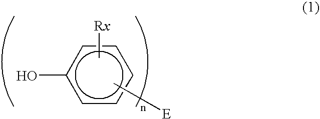
and/or a modified derivative thereof, wherein each R is independently selected from C₁₋₃₀ alkyl and at least one R is in the ortho position with respect to the respect phenolic hydroxy group; X is an integer of 1 to 4; E is C₅₋₅₀ hydrocarbyl or heterocarbyl; and n is an integer of 1 to 4;
said Component B is a compound having a secondary amine structure (b) represented by formula (2): 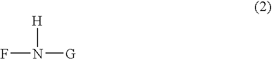
and/or a modified derivative thereof, wherein F and G may be a different or the same type of atom, but is not the same atom; and
said Component C is a compound having both of the group (a) and the group (b) in a molecule and/or a modified derivative thereof.

2. The composition according to claim 1, wherein the total amount of the secondary amine structure contained in Components B and C is from 0.001 to 1.0 milliequivalent per mole of trimethylene terephthalate repeating units and the combined content of Components B and C is from 0.001 to 0.2% by weight relative to the entire composition.

3. The composition according to claim 1, wherein each of the compounds of Components A, B and C is a stabilizer.

4. The composition according to claim 1 which is a polytrimethylene terephthalate composition comprising a polymer component and said Component C, wherein from 10 to 100% by mole of said polymer component is polytrimethylene terephthalate composed of trimethylene terephthalate repeating units.

5. The composition according to claim 1, wherein Component B is at least one selected from the group consisting of a reaction product of N-phenylbenzenamine with 2,4,4-trimethylpentene, 3-(N-salicyloyl)amino-1,2,4-triazole, decamethylene carboxylic acid disalicyloyl hydrazide and modified derivatives thereof.

6. The composition according to claim 1, wherein Component C is at least one selected from the group consisting of N,N-hexane-1,6-diylbis[3-(3,5-di-tert-butyl-4-hydroxyphenyl)propionamide], 2,6-di-tert-butyl-4-(4,6-bis(octylthio)-1,3,5-triazin-2-ylamino)phenol and modified derivatives thereof.

7. The composition according to claim 1, further comprising a compound containing a sulfur atom and/or a modified derivative thereof, wherein said sulfur atom ranges from 0.001 to 1.0 millimole per mole of trimethylene terephthalate repeating units.

8. The composition according to claim 7, wherein the compound containing a sulfur atom comprises a compound having a thioether group and/or a modified derivative thereof.

9. The composition according to claim 1, wherein from 10 to 80% by mole of the polymer component in the composition is composed of trimethylene terephthalate repeating units.

10. The composition according to claim 9, wherein from 10 to 80% by mole of the polymer component in the composition is trimethylene terephthalate composed of trimethylene terephthalate repeating units, and from 90 to 20% by mole of the polymer component is composed of repeating units of at least one resin selected from the group consisting of a polyester, a polycarbonate and a polyolefin, other than polytrimethylene terephthalate.

11. The composition according to claim 9, wherein from 90 to 20% by mole of the composition is at least one polymer selected from the group consisting of polyethylene terephthalate, polybutylene terephthalate, polyethylene naphthalate, a polycarbonate and a copolymer thereof mainly comprising the same.

12. A process for producing the polytrimethylene terephthalate composition according to claim 1, comprising adding a combination of Component A and Component B, and/or Component C, either directly or as a solution or a dispersion in a glycol mainly composed of trimethylene glycol, at any time point during the polymerization to the complete cooling of the product after the completion of the reaction.

13. A process for producing the polytrimethylene terephthalate composition according to claim 1, comprising incorporating a combination of Component A and Component B, and/or Component C during the kneading of the polymer.

14. A fiber or a molded article comprising the polytrimethylene terephthalate composition according to claim 1.

15. The composition according to claim 2, wherein each of the compounds of Components A, B and C is a stabilizer.

16. The composition according to claim 15, wherein Component B is at least one selected from the group consisting of a reaction product of N-phenylbenzenamine with 2,4,4-trimethylpentene, 3-(N-salicyloyl)amino-1,2,4-triazole, decamethylene carboxylic acid disalicyloyl hydrazide and modified derivatives thereof.

17. The composition according to claim 16, wherein Component C is at least one selected from the group consisting of N,N-hexane-1,6-diylbis[3-(3,5-di-tert-butyl-4-hydroxyphenyl)propionamide], 2,6-di-tert-butyl-4-(4,6-bis(octylthio)-1,3,5-triazin-2-ylamino)phenol and modified derivatives thereof.

18. The composition according to claim 17, further comprising a compound containing a sulfur atom and/or a modified derivative thereof, wherein said sulfur atom ranges from 0.001 to 1.0 millimole per mole of trimethylene terephthalate repeating units.

19. The composition according to claim 18, wherein the compound containing a sulfur atom comprises a compound having a thioether group and/or a modified derivative thereof.

20. The composition according to claim 19, wherein from 10 to 80% by mole of the polymer component in the composition is composed of trimethylene terephthalate repeating units.

21. The composition according to claim 20, wherein from 10 to 80% by mole of the polymer component in the composition is trimethylene terephthalate composed of trimethylene terephthalate repeating units, and from 90 to 20% by mole of the polymer component is composed of repeating units of at least one resin selected from the group consisting of a polyester, a polycarbonate and a polyolefin, other than polytrimethylene terephthalate.

22. The composition according to claim 20, wherein from 90 to 20% by mole of the composition is at least one polymer selected from the group consisting of polyethylene terephthalate, polybutylene terephthalate, polyethylene naphthalate, a polycarbonate and a copolymer thereof mainly comprising the same.

23. A process for producing the polytrimethylene terephthalate composition according to any claim 22, comprising adding a combination of Component A and Component B, and/or Component C, either directly or as a solution or a dispersion in a glycol mainly composed of trimethylene glycol, at any time point during the polymerization to the complete cooling of the product after the completion of the reaction.

24. A process for producing the polytrimethylene terephthalate composition according to claim 22, comprising incorporating a combination of Component A and Component B, and/or Component C during the kneading of the polymer.

25. A fiber or a molded article comprising the polytrimethylene terephthalate composition according to claim 22.
